(19) United States
(12) Patent Application Publication
(10) Pub. No.: US 2017/0278114 A1
(43) Pub. Date: Sep. 28, 2017

(54) ADAPTIVE COLLABORATIVE FILTERING WITH EXTENDED KALMAN FILTERS AND MULTI-ARMED BANDITS

(71) Applicant: Xerox Corporation, Norwalk, CT (US)

(72) Inventor: Jean-Michel Renders, Quaix-en-Chartreuse (FR)

(73) Assignee: Xerox Corporation, Norwalk, CT (US)

(21) Appl. No.: 15/079,669

(22) Filed: Mar. 24, 2016

(51) Int. Cl. G06Q 30/02

(52) U.S. Cl. CPC G06Q 30/0202; G06Q 30/0282

(57) ABSTRACT

A method for updating a predicted ratings matrix includes receiving an observation, the observation identifying a user, an item, an observed rating of the user for the item, and a time of the observation. Based on the observation, user and item latent factor matrices and user and item biases are updated using extended Kalman filters. The user latent factor matrix includes latent factors for each of a set of users and the item latent factor matrix includes latent factors for each of a set of items. A predicted ratings matrix is updated as a function of the user latent factor matrix and the item latent factor matrix. Recommendations can be generated using a sampling strategy based on a multi-armed bandit and the posterior distributions given by the extended Kalman filters.

This work was partially funded by the French Government under the grant ANR-13-CORD-0020 (ALICIA Project).

### BACKGROUND

The exemplary embodiment relates to collaborative filtering and finds particular application in recommender systems where item perception and user tastes vary over time.

Recommender systems are designed to provide automatic recommendations to a user by attempting to predict the preferences or choices of the user. Recommender systems are employed in numerous retail and service applications. For example, an online retailer may provide a website through which a user (i.e., a customer) browses the retailer's catalog of products or services. To promote purchases, the retailer would like to identify and present to the customer specific products or services that the customer is likely to want to purchase. The recommender system, in this application, identifies products or services that are likely to be of interest to the customer, and these products are recommended to the customer.

Collaborative filtering is often used in such systems to provide automatic predictions about the interests of a user by collecting rating information from many users. The ratings can be explicit (e.g., a score given by a user) or implicit (e.g., based on user purchases). The method is based on the expectation that if two users have similar opinions on one item (or a set of items) then they are more likely to have similar opinions on another item than a person randomly chosen. For example, collaborative filtering-based recommendations may be made to a user for television shows, movies, books, and the like, given a partial list of that user's tastes. These recommendations are specific to the user, but use information obtained from many users.

In many collaborative filtering applications, the available data is represented in a matrix data structure. For example, product ratings can be represented as a two-dimensional matrix in which the rows correspond to customers (users) and the columns correspond to products (items), or vice versa. The data structure is typically very sparse, as most users have not purchased or reviewed many of the items.

One problem with existing recommender systems is that they often fail to provide the level of reactivity to changes that users expect, i.e., the ability to detect and to integrate changes in needs, preferences, popularity, and so forth. User preferences and needs change over time, either gradually or sharply, e.g., depending on particular events and on social influences. Similarly, item perception may evolve in time, due to a natural slow decrease in popularity or a sudden gain in interest, e.g., after winning an award or receiving positive reviews from influential commentators.

Another problem with many existing methods is that they often lack efficiency and scalability to meet the demands of very large recommendation platforms.

Additionally, existing systems generally do not address the “cold start” case, such as when a user or item is added to the system without any historical information, or when abrupt changes occur.

One approach for addressing temporal effects in recommender systems is known as the timeSVD++ algorithm (Yehuda Koren, “Collaborative Filtering with temporal dynamics,” Communications of the ACM, 53(4):8997, 2010). This approach explicitly models the temporal patterns on historical rating data, in order to remove “temporal drift” biases. This means that the time dependencies are modeled parametrically as time-series, typically in the form of linear trends, with a large number of parameters to be identified. Such a system would be unable to extrapolate rating behavior into the future, as it involves the discretization of the timestamps into a finite set of “bins” and the identification of bin-specific parameters. It is thus impossible to predict ratings for future, unobserved bins.

Other approaches rely on a Bayesian framework and on probabilistic matrix factorization, where a state-space model is introduced to model the temporal dynamics (see, for example, Deepak Agarwal, et al., “Fast online learning through online initialization for time-sensitive recommendation,” Proc. 16th ACM SIGKDD Int'l Conf. on Knowledge Discovery and Data Mining (KDD), pp. 703-712, 2010; Zhengdong Lu, et al., “A spatio-temporal approach to collaborative filtering,” Proc. 3rd ACM Conf. on Recommender Systems (RecSys), pp. 13-20, 2009; and David H Stern, et al., “Matchbox: large scale online Bayesian recommendations,” Proc. 18th Int'l Conf. on World Wide Web (WWW), pp. 111-120, ACM, 2009).

Tensor factorization approaches have also been adopted to model the temporal effects of the dynamic rating behavior (Liang Xiong, et al., “Temporal collaborative Filtering with Bayesian probabilistic tensor factorization,” Proc. SIAM Int'l Conf. on Data Mining (SDM), vol. 10, pp. 211-222, 2010). In this method, user, item and time constitute the three dimensions of the tensors. Variants of this general framework have been proposed which introduce second-order interaction terms and a different definition of the time scale (user- or item-specific time scales, by considering the time interval since the user or item first entered into the system). (L. Xiang, et al., “Time-dependent models in collaborative filtering based recommender system,” IEEE/WIC/ACM Int'l Joint Conf. on Web Intelligence and Intelligent Agent Technologies, 2009 (WI-IAT'09), vol. 1, pp. 450-457, 2009; L. Yu, et al., “Multi-linear interactive matrix factorization,” Knowledge-Based Systems, Vol. 85, Issue C, pp. 307-315, 2015). Tensor factorization is useful for analyzing the temporal evolution of user and item-related factors, but it does not extrapolate rating behavior into the future.

Other approaches propose to incrementally update the item- and user-related factors corresponding to a new observation by performing a stochastic gradient step of a quadratic loss function, but only allowing one factor to be updated. The updating decision is taken based on the current number of observations associated to a user or to an item. Thus, for example, a user with a high number of ratings will no longer be updated. (P. Ott, “Incremental matrix factorization for collaborative filtering,” Science, Technology and Design 01/2008, Anhalt University of Applied Sciences, 2008; S. Rendle, et al., “Online-updating regularized kernel matrix factorization models for large-scale recommender systems,” Proc. 2008 ACM Conf. on Recommender Systems, pp. 251-258, 2008). A similar approach has been extended to a non-negative matrix completion setting by assuming that the item-related factors are constant over time. (S. Han, et al., “Incremental learning for dynamic collaborative filtering,” J. Software, 6(6):969-976, 2011).

The use of Kalman Filters for collaborative filtering has also been proposed. Some methods rely on a Bayesian framework and on probabilistic matrix factorization, where a state-space model is introduced to model the temporal dynamics. (Z. Lu, et al., “A spatio-temporal approach to collaborative filtering,” Proc. 2009 ACM Conf. on Recommender Systems, pp. 13-20, 2009; D. Agarwal, et al., “Fast online learning through offline initialization for time-sensitive recommendation,” Proc. KDD 2010, pp. 703-712, 2010; D. Stern, et al., “Matchbox: large scale online Bayesian recommendations,” Proc. Int'l Conf. on World Wide Web (WWW '09), pp. 111-120, 2009). In one approach, an Expectation-Maximization-like method based on Kalman smoothers (the non-causal extension of Kalman filters) is used to estimate the value of the hyperparameters (J. Sun, et al., “Collaborative Kalman filtering for dynamic matrix factorization,” IEEE Transactions on Signal Processing, 62(14):3499-3509, 2014; J. Sun, et al., “Dynamic matrix factorization: A state space approach,” IEEE Int'l Conf. on Acoustics, Speech and Signal Processing (ICASSP 2012), pp. 1897-1900, 2012). Another approach models the continuous-time evolution of the latent factors through Brownian motion (S. Gultekin et al., “A collaborative Kalman filter for time-evolving dyadic processes,” IEEE Int'l Conf. on Data Mining (ICDM 2014), pp. 140-149, 2014). While such methods could, in theory, be extended to include additional user- or item-related features to address the cold-start problem, in order to remain computationally tractable and to avoid having to tackle non-linearities, they update only either the user factors, or the items factors, but never both factors simultaneously. This amounts to considering only linear state-space models, for which standard (linear) Kalman Filters provide an efficient and adequate solution.

Recently, an incremental matrix completion method has been proposed that automatically allows the latent factors related to both users and items to adapt “on-line” based on a temporal regularization criterion, ensuring smoothness and consistency over time, while leading to very efficient computations (U.S. application Ser. No. 14/669,153; J. Gaillard et al., “Time-sensitive collaborative filtering through adaptive matrix completion,” Adv. in Information Retrieval—Proc. 37th European Conf. on IR Research (ECIR 2015), pp. 327-332, 2015). The method allows updating of both item and user latent factors, but does not address the cold start problem explicitly.

Multi-Armed Bandits have been used for item recommendation (L. Li, et al., “A contextual-bandit approach to personalized news article recommendation,” Proc. 19th Int'l Conf. on World Wide Web (WWW 2010), pp. 661-670, 2010; O. Chapelle et al., “An empirical evaluation of Thompson sampling,” Proc. Adv. in Neural Information Processing Systems (NIPS 2011) vol. 24, pp. 2249-2257, 2011; D. Mahajan, et al., “Log UCB: an explore-exploit algorithm for comments recommendation,” 21st ACM Int'l Conf. on Information and Knowledge Management (CIKM 2012), pp. 6-15, 2012). Some approaches use linear contextual bandits, where a context is typically a user calling the system at time t and an associated feature vector. The reward (i.e., the rating) is assumed to be a linear function of this feature vector. Other approaches consider binary ratings, with a logistic regression model for each item and then use Thompson Sampling or UCB sampling to select the best item following an exploration/exploitation trade-off perspective. Another approach combines Probabilistic Matrix Factorization and linear contextual bandits (X. Zhao, et al., “Interactive collaborative filtering,” 22^{nd} ACM Int'l Conf. on Information and Knowledge Management (CIKM'2013), pp. 1411-1420, 2013). None of these approaches, however, allows an adaptive behavior: the features associated to a user are assumed to be constant and known accurately.

A system and method are provided which allow dynamic tracking of both user and item latent factors while facilitate control of the exploration/exploitation trade-off in an on-line learning setting.

### INCORPORATION BY REFERENCE

The following references, the disclosures of which are incorporated herein by reference, are mentioned:

Recommender systems and collaborative filtering methods are described, for example, in U.S. Pat. No. 7,756,753 and U.S. Pub. Nos. 20130218914, 20130226839, 20140180760, and 20140258027.

An adaptive collaborative filtering method is described in U.S. application Ser. No. 14/669,153, filed Mar. 26, 2015, entitled TIME-SENSITIVE COLLABORATIVE FILTERING THROUGH ADAPTIVE MATRIX COMPLETION, by Jean-Michel Renders.

### BRIEF DESCRIPTION

In accordance with one aspect of the exemplary embodiment, a method for updating a predicted ratings matrix includes receiving an observation, the observation identifying a user, an item, an observed rating of the user for the item, and a time of the observation. User and item latent factor matrices and user and item biases are updated using extended Kalman filters based on the observation. The user latent factor matrix includes latent factors for each of a set of users. The item latent factor matrix includes latent factors for each of a set of items. A predicted ratings matrix is updated as a function of the updated user latent factor matrix and the updated item latent factor matrix.

One or more steps of the method may be performed with a processor.

In accordance with another aspect of the exemplary embodiment, a system for updating a predicted ratings matrix includes an adaptive matrix completion component which updates user and item latent factor matrices and user and item biases using extended Kalman filters based on the observation, the user latent factor matrix including latent factors for each of a set of users, the item latent factor matrix including latent factors for each of a set of items. The component also updates a predicted ratings matrix as a function of the user updated latent factor matrix and the updated item latent factor matrix. A processor device implements the adaptive matrix completion component.

In accordance with one aspect of the exemplary embodiment, a method for making a recommendation includes, for a plurality of iterations, receiving an observation, each observation identifying a user, an item, an observed rating of the user for the item, and a time of the observation, updating user and item latent factor matrices and user and item biases using extended Kalman filters, based on the observations, the user latent factor matrix including latent factors for each of a set of users, the item latent factor matrix including latent factors for each of a set of items, and updating a predicted ratings matrix as a function of the user latent factor matrix and the item latent factor matrix. A request for an item to be recommended to a user is received. An item to recommend to the user is identified using multi-arm bandit sampling and the identified item is output.

One or more steps of the method may be performed with a processor.

### BRIEF DESCRIPTION OF THE DRAWINGS

FIG. 1 is a functional block diagram of an environment in which a recommender system for adaptive collaborative filtering operates;

FIG. 2 illustrates example matrices generated in the system and method;

FIG. 3 illustrates a method for adaptive collaborative filtering; and

FIG. 4 illustrates using observations to update corresponding rows of the latent factor matrices for the corresponding user and item in the method of FIG. 3.

### DETAILED DESCRIPTION

Aspects of the exemplary embodiment relate to a method and system for adaptive collaborative filtering which enable both adaptivity and “cold start” challenges to be addressed through the same framework, namely Extended Kalman Filters (EKF) coupled with contextual Multi-Armed Bandits (MAB). Advantages of the system and method include scalability and tractability, which are useful in systems dealing with large numbers of users and items. Rather than relying on complex inference methods derived from fully Bayesian approaches, a more simplified and efficient method is employed.

The system and method rely on a matrix completion approach to collaborative filtering, which is extended to the adaptive, dynamic case, while controlling the exploitation/exploration trade-off (especially in the “cold start” situations). EKF provide a useful framework for modelling smooth non-linear, dynamic systems with time-varying latent factors (sometimes referred to as “states”). In contrast to conventional filters, which only allow one of the user and item latent factor matrixes to be updated, EKF allow both matrices to vary over time, as well as user and item biases, which is more realistic. The EKF maintain, in particular, covariance estimates over the states (which are covariance matrices for latent factors and scalar values for user and item biases) or, equivalently, a posterior distribution over the user/item biases and latent factors, which are exploited by the MAB mechanism to guide its sampling strategy. In the exemplary embodiment, Iterative Extended Kalman Filters (IEKF) are employed. Two different MAB approaches are described herein by way of example: Thompson sampling, which is based on the probability matching principle, and UCB (Upper Confidence Bound) sampling, which is based on the principle of optimism in face of uncertainty.

The exemplary system and method can be employed in a recommender system as described, for example, in above-mentioned application Ser. No. 14/669,153, incorporated herein by reference. Briefly, when a user u calls the system at time t for a recommendation, an item i is chosen that will simultaneously satisfy the user and improve the quality estimate of the parameters related to both the user u and the proposed item i. When the system then receives a new feedback in the form of a user, item, rating, time tuple (<u,i,r,t> tuple), it updates corresponding entries of user and item latent factor matrices and user and item biases. The present system also updates posterior covariance matrices over the factor estimates. The present system and method provide an algorithm entailing fairly basic algebraic computations, which allows updates to be made without the need for matrix inversion or singular value decomposition. This enables the exemplary algorithm to update the parameters of the model and make recommendations, even with a high arrival rate of, for example, several thousand ratings per second.

The term “user” as used herein encompasses any person acting alone or as a unit (e.g., a customer, corporation, non-profit organization, or the like) that rates items. An “item” as used herein is a product, service, or other subject of ratings assigned by users.

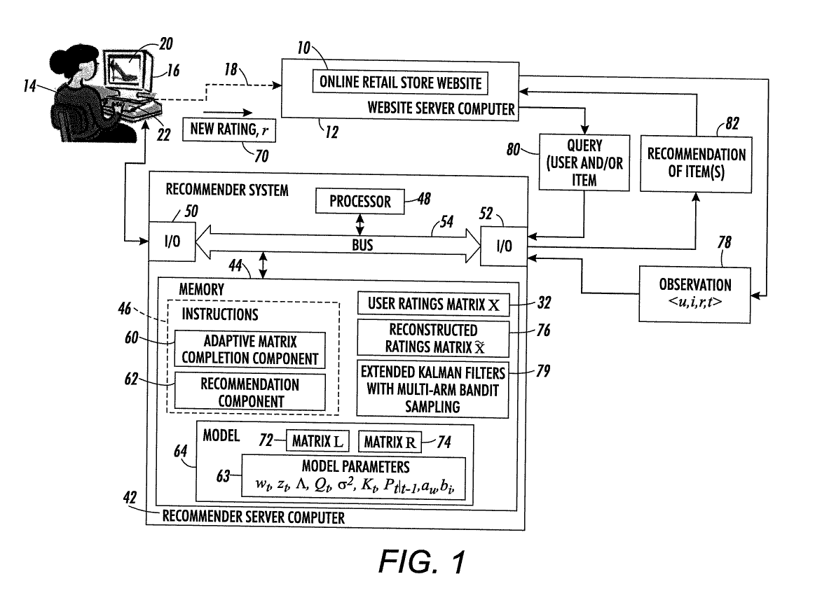

With reference to FIG. 1, in an illustrative example, the users u are customers and the items i are products or services offered by an online retail store website 10 that is hosted by an Internet-based server computer or computers 12. A customer 14 interacts with the online retail store website 10 using an electronic client device 16, such as a desktop computer, notebook computer, electronic tablet, smartphone, or personal data assistant (PDA). The client device 16 is operatively connected with the online retail store website 10 via a wired or wireless connection 18, such as the Internet (diagrammatically indicated by a dashed line). The electronic device 16 includes a display device 20 and a user input device 22, such as a keyboard, keypad, touchscreen, or the like, which in combination enable the user 14 to view item-related information and rate respective items. Although a single electronic device 16 is shown, it is to be understood that the exemplary online retail store website 10 serves many customers who typically each use their own electronic client device or devices to access the website 10. Each customer is uniquely identified to the website, e.g., through a user ID, which may be linked to identifying information, such as an email address and/or IP address of the client device 16.

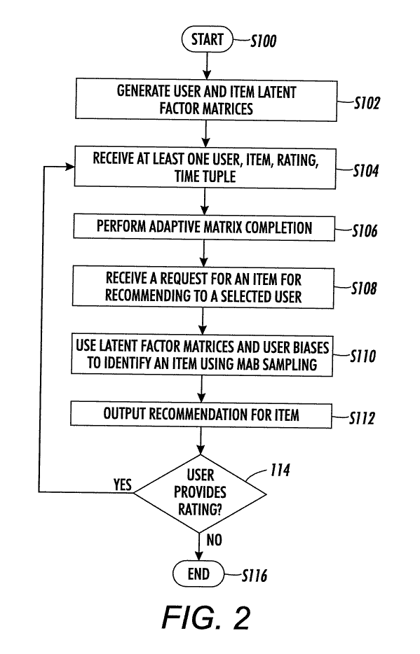

The online retail store website 10 enables users to rate items, such as products or services, which may be available on the website 10, and may be identified by a unique identifier. In an illustrative example, the user ratings (i.e., observed ratings) are on a one-to-five star integer scale. However, any other rating scale can be employed. The ratings are suitably organized in an n×m user ratings matrix 32 (FIG. 2), denoted X, in which the rows (n) correspond to users (i.e., customers in this example) and the columns (m) correspond to items (i.e., products or services in this example). The elements of the matrix are the observed ratings. The illustrative matrix 32 includes only n=6 users and m=7 items. However, the number of users may be in the dozens, hundreds, thousands, tens of thousands, hundreds of thousands, millions, or more; and the number of items may be in the dozens, hundreds, thousands, tens of thousands, hundreds of thousands, millions, or more. The current user ratings matrix 32 is typically sparse since most (user, item) elements do not store a rating (that is, a given customer has typically not rated most items, and a given item typically has not been rated by most customers). Initially, in the cold start case, the matrix 32 may be virtually empty, e.g., with only one user, item, rating observation. In the cold start case, some prior knowledge about the distribution of the parameters (user/item biases/latent factors) may be utilized.

During the course of a user's session on the online retail store website 10, it is advantageous to direct recommendations to the user. For this, the website 10 utilizes a recommender system 40, which may be hosted by the website server computer 12 or by a separate computing device 42, which may be communicatively connected with the computer 12, as illustrated. In the illustrated embodiment, the website server computer 12 and recommender server computer 42 both have access to a database 30, which stores data previously collected from the users, although other arrangements are contemplated. For example, the website 10 may send raw data to the recommender system 40 which generates and stores the matrix 32 locally.

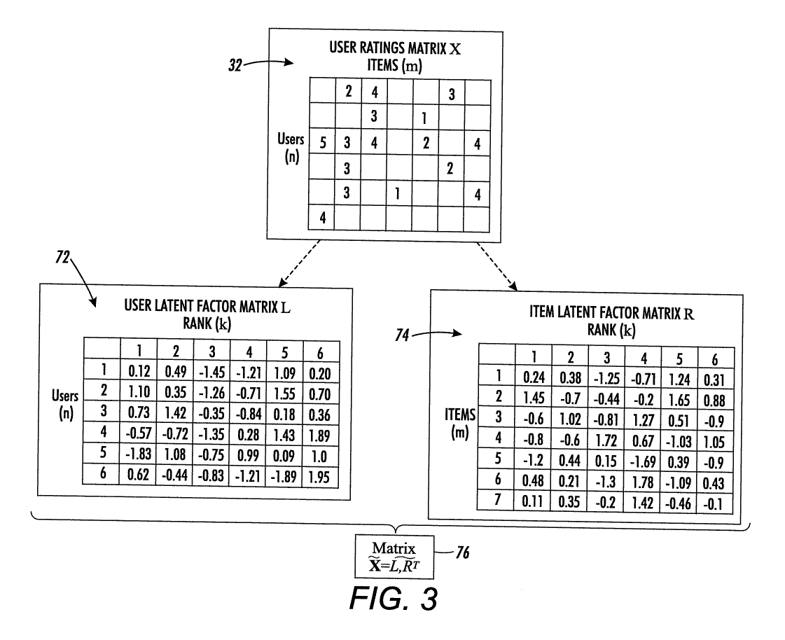

The recommender system 40 includes memory 44 which stores instructions 46 for performing the method described with reference to. FIG. 3 and a processor 48, in communication with the memory, for executing the instructions 46. One or more input/output devices 50, 52 allow the system to communicate with external devices, such as the website server computer 12 and/or directly with customer client devices 16. Hardware components 44, 48, 50, 52 of the system 40 communicate via a data/control bus 54.

The instructions 46 include an adaptive matrix completion (AMC) component 60 and a recommendation component 62.

The AMC component 60 decomposes the user ratings matrix 32 into user and item latent factor matrices 72, 74 denoted L and R, to minimize errors between the current user matrix 32 and a reconstructed predicted ratings matrix 76 (denoted \tilde{X}, where \tilde{X}=LR^{T}). The predicted ratings matrix, unlike the sparse user ratings matrix 32, includes a value in each of the cells for the user, item pairs. When a new observation 78 is received in the form of a tuple: user ID, item ID, rating, time-stamp indicating the time at which the rating was submitted (<u,i,r,t> tuple), the AMC component 60 updates the user and item latent factor matrices 72, 74 and hence the reconstructed matrix 76 as well as user and item biases for the respective user and item. For each rating, the AMC component 60 updates at least one latent factor vector (or row) of the user and item factor matrices 72, 74 and user and item biases. In the exemplary embodiment, this is achieved with Kalman filters 79. The Kalman filter keeps track of the estimated state of the system and the variance (or uncertainty) of that estimate.

The recommendation component 62 receives as input a query 80 from the website 10 and outputs a recommendation 82 based on the updated predicted ratings matrix 76. Various types of query are contemplated. For example, the query 80 may include a user ID and seek a recommendation of an item (or set of n items) to be proposed to the corresponding user 14. To do this, the recommendation component 64 uses a multi-arm bandit approach to Kalman filtering which takes into account the predicted ratings for the items (from the row of the matrix 76 for that user, and also the uncertainty of those predictions. The aim is to satisfy the user 14 by providing a recommendation with a high predicted rating, while at the same time, recommending an item which is expected to reduce the uncertainty in the predictions. Thus, for example, if the user is looking for a movie recommendation and has not yet rated any horror movies, the recommender system may recommend a horror movie to the user, provided that the predicted ratings matrix does not predict very low user ratings for all the horror movies in the collection of items. The rating of the user for this item is thus expected to be informative and lead to better predictions in the future than if the system recommended a Western movie to a user who has already rated a number of Westerns. As will be appreciated, the system may also be used to identify users to make a recommendation for a particular item, based on the predicted ratings that the users would give and the uncertainty in the predictions.

The recommendation 82 is output by the system to the website 10, which may then display one or more of the recommended items to the user on the display 20 of the client device.

The sequence of generating the query 80, receiving the recommendation 82, and displaying the recommendation 82 on the display 20 of the client device 16 can occur in various settings. For example, when a user selects an item for viewing, the online retail store website 10 may generate the query 80 as the (user, item) pair, and then display the store's prediction for the user's rating of the item in the view of the item. To increase user purchases, in another variation when the user views an item in a given department the query 80 is generated as the user alone (not paired with the item) but optionally with the query constrained based on the viewed item (e.g., limited to the department of the store to which the viewed item belongs). The recommended items are then displayed in the view of the selected item, along with suitable language such as “You may also be interested in these other available items:” or some similar explanatory language. The displayed recommended items may be associated with hyperlinks such that user selection of one of the recommended items causes the online retail store website 10 to generate a view of the selected recommended item. In another embodiment, the website may pay for click through advertisements to be displayed next to content on another website. Given the user ID, the recommended items recommended for that user may be displayed in the click-through advertisement (which when clicked on by the user, takes the user to a page of the store website). Or the website may be configured for recommending items to users on request, such as a request for a recommendation of movie currently being shown in the user's neighborhood or a local restaurant.

The computer system 40 may include one or more computing devices 42, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 44 may represent any type of non-transitory computer readable medium such as random access memory (RAM), read only memory (ROM), magnetic disk or tape, optical disk, flash memory, or holographic memory. In one embodiment, the memory 44 comprises a combination of random access memory and read only memory. In some embodiments, the processor 48 and memory 44 may be combined in a single chip. Memory 44 stores instructions for performing the exemplary method as well as the processed data.

The network interface 50, 52 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor device 48 can be variously embodied, such as by a single-core processor, a dual-core processor (or more generally by a multiple-core processor), a digital processor and cooperating math coprocessor, a digital controller, or the like. The digital processor 48, in addition to executing instructions 46 may also control the operation of the computer 42. Computer 12 may be configured similarly to computer 42, with respect to its hardware.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

FIG. 2 illustrates a method for adaptive matrix completion and recommendation. The method starts at S100.

At S102, a sparse user ratings matrix 32 is decomposed into a user latent factor matrix 72 which, for each of a set of users, includes a value for each of a set of K latent factors, and an item latent factor matrix 74 which, for each of a set of items includes a value for each of a set of K latent factors. The product of the latent factor matrices is a reconstructed ratings matrix which includes values for each user item pair. User and item biases

At S104, at least one observation <u,i,r,t> is received and may be stored in memory 44.

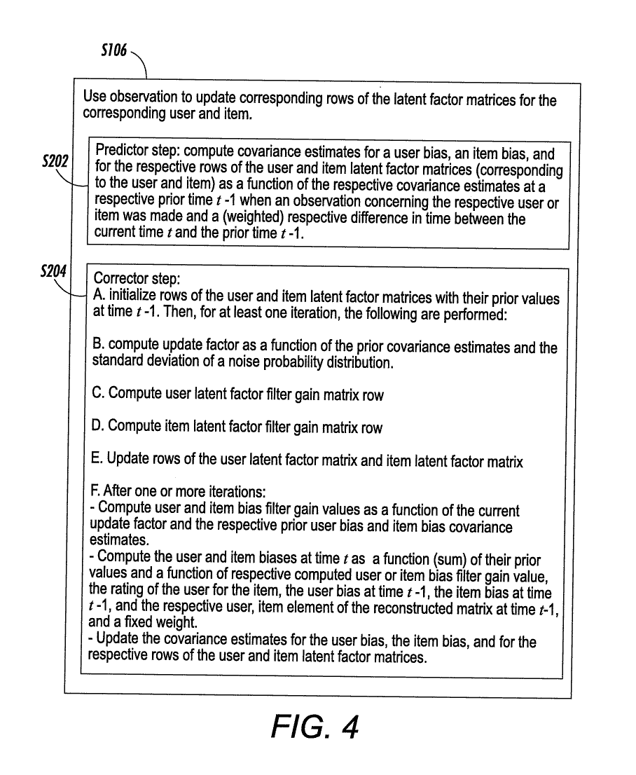

At S106, adaptive matrix completion is performed using Extended Kalman filters for each of the plurality of times t. This step may include the following substeps, as illustrated in FIG. 4.

At each time t, when an observation is received it is used to update corresponding rows of the latent factor matrices 72, 74 for the corresponding user and item. The updating includes a predictor step (S202) and an iterative corrector step (S204). In the predictor step, covariance estimates are computed for a user bias, an item bias, and for the respective rows of the user and item latent factor matrices (corresponding to the user and item) as a function of the respective covariance estimates at a respective prior time t−1 when an observation concerning the respective user or item was made and a (weighted) respective difference in time between the current time t and the prior time t−1.

In the corrector step, rows of the user and item latent factor matrices are initialized with their prior values at time t−1 (S206A). Then, for at least one iteration, the following are computed:

S206B. An update factor is computed as a function of the prior covariance estimates and the standard deviation of a noise probability distribution.

S206C. A user latent factor filter gain matrix is then computed for the row of the user latent factor matrix corresponding to the user as a function of the update factor, the user bias covariance estimate at time t, and the respective row of the user latent factor matrix.

S206D. An item latent factor filter gain matrix is computed for the row of the item latent factor matrix corresponding to the item as a function of the update factor, the user bias covariance estimate at time t, and the respective row of the item latent factor matrix.

S206E. The respective rows of the user latent factor matrix and item latent factor matrix are each updated as a function of the respective filter gain matrix, the rating of the user for the item, the user bias at time t−1, the item bias at time t−1, and the respective user, item element of the reconstructed matrix at time t−1, and a fixed weight. After one or more iterations, at S206F, user and item bias filter gain values are computed as a function of the current update factor and the respective prior user bias and item bias covariance estimates, the user and item biases at time t are each computed as a function (e.g., sum) of their prior values and a function of respective computed user or item bias filter gain value, the rating of the user for the item, the user bias at time t−1, the item bias at time t−1, and the respective user, item element of the reconstructed matrix at time t−1, and the fixed weight. The covariance estimates for the user bias, the item bias, and for the respective rows of the user and item latent factor matrices are also updated.

In the case when no training data has been observed for a particular user/item, i.e., the cold start case, the covariance estimates for the user bias, item bias, and the latent factor matrices can be set to relatively large values (corresponding to the large variance of the prior distributions over the model parameters), which are expected to reduce when more observations of these items/users are made.

At S108, a request is received for an item for proposing to a selected user.

At S110, the current latent factor matrices and user biases are used to select an item to sample, using one of the MAB sampling methods to provide a tradeoff between exploration and exploitation.

At S112, the recommendation is output.

If at S114, the user provides a rating of the proposed item, or another user provides a rating of an item, the method returns to S102. Otherwise the method ends at S116.

Further details of the system and method will now be provided.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

The training data (observations 78) comprises or consists of a sequence of tuples <user,item,rating,time-stamp>. Since the training data is very sparse (users only rate a small proportion of the items), a matrix factorization approach to collaborative filtering is used in which a user ratings matrix 32 is decomposed into user and item latent factor matrices 72, 74 and user and item biases, which minimize the errors between the original user ratings matrix and a reconstructed user ratings matrix 76. The number K of latent factors can be manually selected or determined automatically. In general, K<<n, and K<<m, e.g., K is at least 5, or at least 10, or at least 20, or at least 50. In this setting, each observed rating can be modeled as:

r_{u,i}=μ+aᵤ+bᵢ+Lᵤ·Rᵢ^{T}+ε

where μ represents a fixed weight, aᵤ, bᵢ, Lᵤ and Rᵢ are latent variables, respectively a user bias, an item popularity (bias), the user latent factors, and the item latent factors. T represents the transpose operator. Lᵤ and Rᵢ are row vectors of the respective latent factor matrices 72, 74, with K components (each with a rank k), K being the dimensionality of the latent space. The noise E is assumed to be i.i.d. (independent and identically distributed) Gaussian noise, with mean equal to 0 and variance equal to the square of the standard deviation σ². The completion of the reconstructed user ratings matrix 76 may involve minimization of a loss function which combines the reconstruction error over the training set and regularization terms, e.g., as follows:

[symbol]

(a,b,L,R)=Σ_{(u,i)εΩ}|rᵤᵢ−μ−aᵤ−bᵢ−Lᵤ·Rᵢ^{T}∥²+λₐ∥a∥²+λ_{b}∥b∥²+λ_{L}∥L∥_{F}²+λ_{R}∥R∥_{F}² (1)

where:
Ω is the training set of observed tuples 78.
∥a∥² represents the squared norm (e.g., Euclidean norm) of the respective user biases, ∥b∥² represents the squared norm (e.g., Euclidean norm) of the respective item biases.
∥L∥_{F}² is the squared Frobenius norm of the latent factor matrix L and ∥R∥_{F}² is the squared Frobenius norm of the latent factor matrix R. The squared Frobenius norm is the sum of the squares of each element (entry) of the matrix. The Frobenius norm is effective as it easily tractable. However other matrix norms can be used, such as the L₁ norm (the sum of absolute values of all elements).
λₐ, λ_{b}, λ_{L}, λ_{R} are parameters of the respective regularization terms and are all scalars.

The minimization of the loss function can be solved by gradient descent (optionally accelerated by the Limited Memory Broyden-Fletcher-Goldfarb-Shanno (L-BFGS) quasi-Newton method), as described in Malouf, R., “A comparison of algorithms for maximum entropy parameter estimation,” Proc. Sixth Conf. on Natural Language Learning (CoNLL), pp. 49-55 (2002), or by Alternating Least Squares (for Lᵤ and Rᵢ).

It may be noted that this loss could alternatively be interpreted in a Bayesian setting as the Maximum A Posteriori (MAP) estimate, provided that all the latent parameters (aᵤ, bᵢ, Lᵤ and Rᵢ) have independent Gaussian priors, with diagonal covariance matrices. In this case,

$${λ}_{L} = \frac{{σ}^{2}}{{σ}_{L}^{2}}$$

where σ_{L}² is the variance of the diagonal Gaussian prior on Lᵤ; with λᵤ, λ_{b} and λ_{R} being computed correspondingly:

$${λ}_{a} = \frac{{σ}^{2}}{{σ}_{a}^{2}} ; {λ}_{b} = \frac{{σ}^{2}}{{σ}_{b}^{2}} ; {λ}_{R} = \frac{{σ}^{2}}{{σ}_{R}^{2}} .$$

### Adaptive Matrix Completion (S106)

The above describes a static setting. It is assumed, however, that the model parameters evolve over time, and have their own dynamics. The evolution is dependent on the time between observations. Since some of the latent variables result from rare observations, they tend to have a high variability, while others that result from more frequent observations show less variability between observations. As an example, if a user has recently been observed, it can be assumed that the latent factors for that user have not changed much in the intervening period, whereas for a user who was last observed a long time ago, the latent factors can be assumed to have a much higher variability.

One approach to reconstructing the evolution of these parameters (considered as latent variables) from the sequence of observations relies on the use of Extended Kalman Filters (EKF), which are a non-linear version of Kalman Filters. As used herein, EKF are a generalization of recursive least squares for dynamic systems with “smooth” non-linearities and aim at estimating the current (hidden) state of the system:

xₜ=ƒ(xₜ₋₁)+Wₜ

yₜ=h(xₜ)+zₜ

x₀:N(x*₀,Λ)

wₜ:N(0,Qₜ)

zₜ:N(0,σₜ²)

where N(m,C) denotes a multi-variate Gaussian distribution with mean m and covariance matrix C, (where the mean m is 4 for x*₀ and x₀ for wₜ and zₜ and the covariance matrix C is Λ for x₀, Qₜ for Wₜ and σₜ² for zₜ),
x (ε [symbol] ^{K}) is the latent state of the system, i.e., x₀ is the initial latent state of the system at time t=0, xₜ the latent state at time t, and xₜ₋₁ is the state at a previous time t−1,
yₜ (ε [symbol] ^{N}) is the observable output at time t,
ƒ and h are each a differentiable function,
Wₜ and zₜ are respective multivariate zero mean Gaussian white noises at time t, with covariance matrices Qₜ and σₜ², respectively.

The function ƒ can be used to generate a prediction of the latent state xₜ, denoted \hat{x}ₜ, from the previous estimate and similarly the function h can be used to compute the predicted observation ŷₜ from the predicted state.

The Kalman Filters follow a general predictor-corrector (update) scheme, in which a predictor step is performed to predict the state based on the prior state of the system, and a corrector step which updates the state estimate based on an observation. A filter gain matrix Kₜ, which is applied to the prediction error at time t, and a covariance matrix P_{t|t} of the posterior distribution of the state estimates are maintained and updated.

In the predictor step, the state at time t (\hat{x}_{t|t-1}) is estimated as a time-dependent function of the estimate of the state at a previous time t−1. The predicted covariance estimate at time t (P_{t|t-1}) is then computed as a function of the estimated state at time t, the predicted covariance estimate at time t−1 (P_{t-1|t-1}) and the covariance matrix Qₜ for xₜ:

Predictor Step:

Predicted state estimate:

\hat{x}_{t|t-1}=ƒ(\hat{x}_{t-1|t-1})

Predicted covariance estimate:

P_{t|t-1}=J_{ƒ}(\hat{x}_{t|t-1})P_{t-1|t-1}J_{ƒ}(\hat{x}_{t|t-1})^{T}+Qₜ

where J_{ƒ} is the Jacobian matrix of the function ƒ (J_{ƒ} is defined by

$$\frac{\partial f}{\partial {x}_{t}} ) .$$

In the corrector step, the filter gain matrix Kₜ is computed as a function of the estimated covariance estimate P_{t|t-1} and the estimate of the state at time t (\hat{x}_{t|t-1}), obtained from the predictor step, and the covariance σₜ².

The state estimate is then updated as a function of \hat{x}_{t|t-1} computed in the predictor step, the filter gain matrix Kₜ and the difference between the actual observation yₜ and the predicted observation at time t, computed as h(\hat{x}_{t|t-1}). The covariance estimate is also updated as a function of the filter gain matrix Kₜ, and the predicted covariance estimate at time t (P_{t|t-1}).

Corrector Step:

Filter gain matrix:

Kₜ=P_{t|t-1}Jₕ(\hat{x}_{t|t-1})^{T}(Jₕ(\hat{x}_{t|t-1})P_{t|t-1}Jₕ(\hat{x}_{t|t-1})^{T}+σₜ²)⁻¹

Updated state estimate:

\hat{x}_{t|t}=\hat{x}_{t|t-1}+Kₜ·[yₜ−h(\hat{x}_{t|t-1})]

Updated covariance estimate:

P_{t|t}=[I−KₜJₕ(\hat{x}_{t|t-1})]P_{t|t-1}

where Jₕ is the Jacobian matrix of the function h (Jₕ is defined by

$$\frac{\partial h}{\partial {x}_{t}} ) .$$

In practice, an Iterated Extended Kalman Filter (IEKF) can be used, where the first two equations of the Corrector step are iterated until \hat{x}_{t|t}⁽ⁱ⁾ is stabilized, gradually offering a better approximation of the non-linearity through the Jacobian matrices.

In order to apply these filters, the adaptive collaborative filtering can be expressed as a continuous-time dynamic system with the following equations, assuming that the tuple <u,i,r_{u,i}> is observed at time t:

a_{u,t}=a_{u,t-1}+wₐ(μ,t−1,t)

b_{i,t}=b_{u,t-1}+w_{b}(i,t−1,t)

L_{u,t}=L_{u,t-1}+W_{L}(u,t−1,t)

R_{i,t}=R_{i,t-1}+W_{R}(i,t−1,t)

r_{u,i,t}=μ+a_{u,t}+b_{i,t}+L_{u,t}·R_{i,t}^{T}+εₜ

where a_{u,0}˜N(0,λₐ), b_{i,0}˜N(0,λ_{b}), L_{u,0}˜N(0,λ_{L}), R_{i,0}˜N(0,λ_{R}) and εₜ˜N(0,σ²),

a_{u,t-1} denotes the value of the bias of user u when that user last appeared in the system before time t. Similarly, b_{i,t-1} denotes the value of the popularity of item i when it appeared in the system for the last time before time t. The abbreviated notation (t−1), as used herein, is thus contextual to an item and to a user. The symbol ˜ denotes “drawn from the distribution.”

wₐ(u,t−1,t), w_{b}(i,t−1,t), W_{L}(u,t−1,t), and W_{R}(i,t−1,t) are noises whose variance depends on the time lapse since the last occurrence of a user (for wₐ and W_{L}) or of an item (for w_{b} and W_{R}). This defines a brownian motion for the temporal evolution of the parameters.

εₜ represents the noise in the observation (rating) at time t and is assumed to be i.i.d. (independent and identically distributed) Gaussian noise, with mean equal to 0 and variance equal to the square of the standard deviation σ².

The parameters aᵤ, bᵢ, Lᵤ and Rᵢ are thus all assumed to follow some kind of Brownian motion (the continuous counter-part of a discrete random walk) with Gaussian noises whose respective variances are proportional to the time interval since a user/an item appeared in the system for the last time before the current time, denoted respectively as Δᵤ(t−1, t) and Δᵢ(t−1, t): wₐ(u,t−1,t)˜N(0,Δᵤ(t−1, t)·γₐ), w_{b}(i,t−1,t)˜N(0,Δᵢ(t−1,t)·γ_{b}), W_{L} (u,t−1,t)˜N(0,Δᵤ(t−1,t)˜Γ_{L}) and W_{R}(i,t−1,t)˜N(0,Δᵢ(t−1,t)·Γ_{R}).

γₐ, γ_{b}, Γ_{L} and Γ_{R} are referred to as volatility hyper-parameters. It can be assumed that the hyper-parameters λₐ, γₐ and the diagonal covariance matrices Λ_{L}, Γ_{L} are identical for all users, and independent from each other. The same can be assumed for the hyper-parameters related to items.

With these assumptions, the application of the Iterated Extended Kalman filter equations gives:

Predictor Step:

P_{t|t-1}^{a}^{ᵤ}=P_{t-1|t-1}^{a}^{ᵤ}+Δᵤ(t,t−1)γₐ

P_{t|t-1}^{b}^{ᵢ}=P_{t-1|t-1}^{b}^{ᵢ}+Δᵢ(t,t−1)γ_{b}

P_{t|t-1}^{L}^{ᵤ}=P_{t-1|t-1}^{L}^{ᵤ}+Δᵤ(t,t−1)Γ_{L}

P_{t|t-1}^{R}^{ᵢ}=P_{t-1|t-1}^{R}^{ᵢ}+Δᵢ(t,t−1)Γ_{R}

In the predictor step, therefore, covariance estimates P_{t|t-1}^{a}^{ᵤ}, etc., are computed for the user bias aᵤ, the item bias bᵢ, and the respective rows of the latent factor matrices Lᵤ,Rᵢ as a function (sum) of the respective covariance estimates at a respective prior time t−1 (i.e., when an observation concerning the respective user or item was made) and the respective difference in time between the current time t and the prior time t−1, weighted by a respective volatility hyperparameter γₐ, etc., which, as noted above, can be the same for all users/items, or different. Covariance estimates P_{t|t-1}^{a}^{ᵤ}, P_{t|t-1}^{b}^{ᵢ}, P_{t-1|t-1}^{a}^{ᵤ}, and P_{t-1|t-1}^{b}^{ᵢ} are scalar values and P_{t|t-1}^{L}^{ᵤ}, P_{t-1|t-1}^{L}^{ᵤ}, P_{t|t-1}^{R}^{ᵢ}, P_{t-1|t-1}^{R}^{ᵢ} are matrices.

Corrector Step:

Initialize [symbol] ← [symbol] and [symbol] ←

[symbol]

(the accent ̂ denotes an estimate of the respective value)

Iterate until convergence:

ω=(σ²+P_{t|t-1}^{a}^{ᵤ}+P_{t|t-1}^{b}^{ᵢ}+ [symbol] P_{t|t-1}^{L}^{ᵤ} [symbol] + [symbol] P_{t|t-1}^{R}^{ᵢ} [symbol] )⁻¹

Kₜ^{L}^{ᵤ}=ωP_{t|t-1}^{L}^{ᵤ}

[symbol]

Kₜ^{R}^{ᵢ}=ωP_{t|t-1}^{R}^{ᵢ}

[symbol]

[symbol]

= [symbol] +Kₜ^{L}^{ᵤ}(r_{u,i,t}−μ− [symbol] − [symbol] − [symbol] [symbol] )

[symbol]

= [symbol] +Kₜ^{R}^{ᵢ}(r_{u,i,t}−μ− [symbol] − [symbol] − [symbol] [symbol] )

Then:

Kₜ^{a}^{ᵤ}=ωP_{t|t-1}^{a}^{ᵤ}

Kₜ^{b}^{ᵢ}=ωP_{t|t-1}^{b}^{ᵢ}

[symbol]

= [symbol] +Kₜ^{a}^{ᵤ}(r_{u,i,t}−μ− [symbol] − [symbol] − [symbol] [symbol] )

[symbol]

= [symbol] +Kₜ^{b}^{ⱼ}(r_{u,i,t}−μ− [symbol] − [symbol] − [symbol] [symbol] )

P_{t|t}^{a}^{ᵤ}=P_{t|t-1}^{a}^{ᵤ}(1−Kₜ^{a}^{ᵤ})

P_{t|t}^{b}^{ᵢ}=P_{t|t-1}^{b}^{ᵢ}(1−Kₜ^{b}^{ᵢ})

P_{t|t}^{L}^{ᵤ}=(I−Kₜ^{L}^{ᵤ}R_{i,t})P_{t|t-1}^{L}^{ᵤ}

P_{t|t}^{R}^{ᵢ}=(I−Kₜ^{R}^{ᵢ}L_{u,t})P_{t|t-1}^{R}^{ᵢ}

with P_{0|0}^{a}^{ᵤ}=λₐ, P_{0,0}^{L}^{ᵤ}=Λ_{L} ∀u, and P_{0|0}^{b}^{ᵢ}=λ_{b}, P_{0|0}^{R}^{ᵢ}=Λ_{R} ∀i.

lower case (e.g., λ) generally being used to denote scalars and upper case (e.g., Λ) for denoting matrices. ω, Kₜ^{a}^{ᵤ}, Kₜ^{b}^{ᵢ}, P_{t|}^{a}^{ᵤ} and P_{t|}^{b}^{ᵢ} are all scalars.

In practice, it has been found that the iterative part of the Corrector step may converge in only a few iterations (such as 2 or 3). It should be noted that, if a user is not well known (high covariance P^{a}^{ᵤ} and P^{L}^{ᵤ} due to a low number of ratings or a long time since her last appearance), her weight (and so her influence) in adapting the item i is decreased, and vice-versa.

The net effect is generally that if more observations are received in a relatively short period of time, the uncertainty (covariance estimate) decreases. The aim, however, is not to have the parameters converge to zero, since it is assumed that these parameters vary over time.

The independence and Gaussian assumptions make it simple to compute the posterior distribution of the rating of a new pair <u,i> at time t: it is a Gaussian with mean μ+ [symbol] + [symbol] + [symbol] [symbol] and variance σ²+P_{t|t}^{a}^{ᵤ}+P_{t,t}^{b}^{ᵢ}+ [symbol] P_{t|t}^{L}^{ᵤ} [symbol] + [symbol] P_{t|t}^{R}^{ᵢ} [symbol] .

In one embodiment, the IEKF method may be extended to introduce any smooth non-linear link function (e.g., r_{u,i,t}=g(μ+ [symbol] + [symbol] + [symbol] [symbol] +εₜ), with g(x) being a sigmoid between the minimum and maximum rating values. This extension includes pre-multiplying each occurrence of P_{t|t-1}^{{.} by the derivative of the g sigmoid at the current point (μ+} [symbol] ⁺ [symbol] ⁺ [symbol] [symbol] ^{) in the equations of the corrector step.}

The hyper-parameters may be learned from training data through a procedure similar to the EM algorithm using Extended Kalman smoothers (a forward-backward version of the Extended Kalman Filters) as described, for example, in J. Sun, et al., “Collaborative Kalman filtering for dynamic matrix factorization,” IEEE Transactions on Signal Processing, 62(14):3499-3509, 2014, or by tuning them on a development set, whose time interval is later than the training set.

One property of the exemplary method is that it is easily parallelizable. This is because a tuple <i,j,r_{i,j}> will only modify the estimated parameters CU, [symbol] , [symbol] , [symbol] and the variances/covariances P_{t|t}^{a}^{ᵤ}, P_{t|t}^{b}^{ᵢ}, P_{t|t}^{L}^{ᵤ}, P_{t|t}^{R}^{ᵢ} Therefore, updating the matrices with p tuples with no common users and no common items (as is commonly the case), can be done in parallel on p processors with a shared memory.

### Exploration—Exploitation Trade-Off for Cold-Start and Change Tracking

Let θ denote the set of all parameters (biases aᵤ, bᵢ and latent factors Lᵤ, Rᵢ, for all u and i). If the true parameters θ* were known, for a given context (user u at time t), the system should recommend an item i* such that i*=argmaxᵢ E(r|u,i,θ*) with P(r|u,i,θ*)˜N(μ+L*ᵤRᵢ^{T}*+a*ᵤ+b*ᵢ, σ²). If θ* is not known, it would be possible to marginalize over all possible 6 through the use of the posterior p(θ|D) with D=training data. This amounts to choosing i*=argmaxᵢμ+ [symbol] [symbol] + [symbol] + [symbol] , if a Maximum Posterior solution (MAP) is adopted. However, this is a “one-shot” approach, considered as pure exploitation. As the setting is a multi-shot one, it is desirable to balance exploitation and exploration, which can be expressed by the concept of “regret” (the difference in expected rewards or ratings between a strategy that knows the true θ* and the one based on a current estimate θ^{t}).

One or both of the following two different sampling strategies may be used to control this trade-off: Thompson sampling, based on the “probability matching” principle, and UCB (Upper Confidence Bounds) sampling, based on the principle of optimism in the face of uncertainty. See, for example, O. Chapelle, et al., “An empirical evaluation of Thompson sampling,” Proc. Adv. in Neural Information Processing Systems (NIPS), vol. 24, pp. 2249-2257 (2011), hereinafter, Chapelle 2011) for an introduction to these strategies in the context of recommendation. A “contextual bandit” setting is assumed. This means that at each time step t, a context given by a single user u is observed, characterized by an imperfect estimate of her bias aᵤ and latent factors Lᵤ (some kind of noisy context), and the system should then recommend an arm (i.e., an item) such that the choice of this arm will simultaneously satisfy the user and improve the quality of the estimates of the parameters related to both the user u and the proposed item i.

1. Thompson Sampling

The Thompson Sampling strategy can be expressed by Algorithm 1:

Algorithm 1: Thomson Sampling

```
D=some past data (possibly empty), made up of tuples < u, i, r >
  for t = 1: T do
    Receive uₜ;
    Draw \tilde{θ}ₜ= ã_{u,t} , \tilde{b}_{i,t}, \tilde{L}_{u,t}, \tilde{R}_{i,t} according to p(θ|D) (multi-variate normal
    distribution with mean and covariance matrices computed by IEKF, as
    described above)
    Select item i*: argmaxᵢ E(r|u, i, θₜ) = argmaxᵢ μ + \tilde{L}_{u,t}\tilde{R}_{i,t}^{T} + ã_{u,t} + \tilde{b}_{i,t}
    Observe rating rₜ (for pair < uₜ, i* >)
    Update D
    Update the parameters and the variances/covariances through IEKF,
    as described above.
end for
```

Algorithm 1 considers a set of times from t=1 to t=T. At each time, the identifier of a particular user is received, i.e., one of the set of users. The parameters \tilde{θ}ₜ=ã_{u,t}, \tilde{b}_{i,t}, \tilde{L}_{u,t}, \tilde{R}_{i,t} are drawn from probability distributions generated from the training data, such as the observations obtained to date. An item to propose to the user is then selected which maximizes over all items, the expected reward (or score), denoted E(r|u,i,θₜ), which is computed as the maximum, over all i, of the mean μ of the predicted rating distribution plus the product of the sampled \tilde{L}_{u,t},\tilde{R}_{i,t}, to which the sampled ã_{u,t} and, \tilde{b}_{i,t} are added. The item i* is proposed to the user and, assuming that the user provides a rating rₜ for that item, the rating is used to update the training data (D=D∪uₜ, i*,rₜ. The parameters and their variances/covariances are then updated by the iterative Extended Kalman Filtering method, e.g., IEKF.

In one embodiment, the “Optimistic Thompson sampling” variant may be used (see, Chapelle 2011). This results in the score never being smaller than the mean score. More precisely, in Algorithm 1, E(r|u,i,θₜ) is replaced by max (μ+\tilde{L}_{u,t}\tilde{R}_{i,t}+ã_{u,t}+\tilde{b}_{i,t}, μ+ [symbol] [symbol] + [symbol] + [symbol] ). Additionally or alternatively, the variance/covariance values/matrices may be pre-multiplied by a factor, such as 0.5, to favor exploitation.

2. UCB-Like Sampling

The Upper-Confidence-Bounds (UCB) algorithm can be represented in the pseudo-code shown in Algorithm 2:

Algorithm 2: UCB-like Sampling

```
D=some past data (possibly empty)
for t = 1: T do
  Receive uₜ
  Select item i*:
        argmaxᵢ μ + [symbol] [symbol]    + [symbol]   + [symbol]
                    + α\sqrt{σ² + P_{t|t}^{a}ᵤ + P_{t|t}^{b}ᵢ + [symbol]   P_{t|t}^{L}ᵤ [symbol]   + [symbol]   P_{t|t}^{R}ᵢ [symbol] }
  Observe rating rₜ (for pair < uₜ, i* >), update D, update the parameters
  and variances/covariances through IEKF
end for
```

Here, in the selection step, \sqrt{σ²+P_{t|t}^{a}^{ᵤ}+P_{t|t}^{b}^{ᵢ}+ [symbol] P_{t|t}^{L}^{ᵤ} [symbol] + [symbol] P_{t|t}^{R}^{ᵢ} [symbol]} is used in computing the expected reward. The α parameter controls the trade-off between exploration and exploitation (in practice, α may be at least 0.5, such as α=2).

The Thompson sampling method provides a sampling from the set of items as a function of the respective distribution of predicted ratings and the uncertainty in the predicted ratings. For uncertain items the bell-shaped distribution is wide, whereas for items with lower uncertainty, the bell-shaped distribution is more peaked around the mean predicted rating, and the sampled predicted rating is likely to be closer to the mean. In the case of UCB sampling, an optimistic approach is taken, with only the part of the distribution of predicted ratings for an item that is above the mean (up to an upper cutoff, of around two times the standard deviation, for example) being considered.

Whichever method of MAB sampling is used, the item recommended to the user may not be the one whose mean predicted rating is not as high as for another item, but for which the uncertainty in that prediction is relatively high, which will lead to improvements in the system in the future, assuming that the user rates the item.

Other approaches for selecting an item to recommend to a user may be used instead of, or in combination with, one or both of the MAB approaches described herein. For example, the method described in application Ser. No. 14/669,153 could be employed.

### Applications of the System and Method

Item recommendation is used in many applications. Items may be product in an online store, services, such as restaurants, movies, workers/jobs in an HR scenario, locations or paths in transport applications, advertising tags and creatives in on-line display advertising problems. In these recommendation scenarios, the environment can be highly dynamic and not stationary, which precludes the use of standard static recommendation algorithms. Moreover, the arrival rate of new users or new items is, in general, very high, so that solving the cold start problem is very useful.

Without intending to limit the scope of the exemplary embodiment, the following examples illustrate the application of the system and method.

### Examples

Experiments have been performed on 2 datasets: MovieLens 10M and Vodkaster (Vodkaster (http://www.vodkaster.com) is a French movie recommendation website, dedicated to rather movie-educated people. Each dataset is divided into 3 temporal, chronologically ordered, splits: Train (90%), Development (5%), and Test (5%). Before using the data, the ratings corresponding to the early, non-representative (transient) time period are removed from both datasets (2.5M ratings for MovieLens, 0.3M ratings for Vodkaster). The Development set is used to tune the different hyper-parameters of the algorithm. These two datasets show very different characteristics, as illustrated in Table 1, especially in the arrival rate of new users.

TABLE 1
Dataset Statistics

| | MovieLens | Vodkaster |
|---|---|---|
| Number of ratings | 7,501,601 | 2,428,163 |
| Median number of ratings/user | 92 | 11 |
| Median number of ratings/item | 121 | 7 |
| % of users with at least 100 ratings | 47 | 24 |
| Total time span (years) | 9.02 | 3.7 |
| Duration Dev Set (months) | 7 | 3 |
| Duration Test Set (months) | 7 | 3 |
| % of new users in Dev Set | 72.6 | 35.6 |
| % of new items in Dev Set | 4.2 | 4.3 |
| % of new users in Test Set | 79.4 | 35.4 |
| % of new items in Test Set | 3.2 | 2.2 |

The experiments are divided into two parts: one assessing separately the adaptive capacities of our method, the other evaluating the gain of coupling these adaptive capacities with Multi-Armed Bandits.

### 7.1 Extended Kalman Filters for Adaptive Matrix Completion

The experimental protocol is the following: the Extended Kalman Filters are run from the beginning of the training dataset, initializing the item and user biases to 0 and the latent factors to small random values drawn from the Gaussian prior distributions with covariance matrices Λ_{L} and Λ_{R} for all users and all items respectively. The number of latent factors K is set to 20, without any tuning. Each user is associated to her own time origin (t=0 when the user enters in the system for the first time), and similarly for the items. The values of the hyper-parameters to be tuned are the four variances of the priors and the four volatility values. It can be shown that all values of the hyper-parameters can be divided by σ² without changing the predicted value; so σ² can be set to 1. The parameter values chosen are the ones that optimize the Root-Mean-Squared-Error (RMSE) on the Development set. The Test set is then used to evaluate the RMSE of the predictions, as well as the Mean Absolute Error (MAE) and the average Kendall correlation coefficient (for users with at least two ratings in the Test set). Alternative methods considered are:

(1) the static setting, where matrix factorization is derived from the ratings of the Training and Development sets (hyper-parameters tuned on the Development set) and the extracted models are then applied to the Test set;

(2) Stochastic Gradient Descent applied to the biases and latent factors, with constant learning rates (four different learning rates: one for aᵤ, one for bᵢ, one for Lᵤ and one for Rᵢ);

(3) the on-line Passive-Aggressive algorithm to incrementally update the biases and latent factors as described in K. Crammer, et al., “Online passive-aggressive algorithms,” J. Machine Learning Res., (7) pp. 551-585, 2006;

(4) Linear Kalman Filters applied to update only the user biases and latent factors.

The statistical significance of the differences in performance of the exemplary method with respect to the alternative approaches is evaluated, through paired t-tests on the paired sequences of measures (squared residuals for RMSE, absolute residuals for MAE, and Kendall's tau for each user).

In TABLE 2, numbers in bold indicate that the p-value of the corresponding test is smaller than 1% (hypothesis HO: population with equal mean). The results show that the proposed method significantly improves the performances according to all RMSE, MAE and Kendall's tau metrics (Table 2). Trends are very similar for both MovieLens and Vodkaster datasets, despite their different characteristics. One particular advantage of the present method is the ability to maintain, without cost, a posterior distribution over the parameters and the prediction itself, which is a constituent for the sampling strategies of the MAB mechanism.

TABLE 2
Adaptive Collaborative Filtering Performance

| | | | Kendall's |
|---|---|---|---|
| | RMSE | MAE | Tau |
| Movie Lens | | | |
| (1) Static Setting | 0.8903 | 0.6712 | 0.3261 |
| (2) SGD | 0.8124 | 0.6115 | 0.3544 |
| (3) On-line Passive Aggressive | 0.8035 | 0.6048 | 0.3589 |
| (4) Linear Kalman Filters (user only) | 0.7884 | 0.5959 | 0.3662 |
| (5) Extended (non-linear) Kalman Filters | 0.7669 | 0.5724 | 0.3881 |
| Vodkaster | | | |
| (1) Static Setting | 0.8662 | 0.6598 | 0.4197 |
| (2) SGD | 0.7874 | 0.5995 | 0.4481 |
| (3) On-line Passive Aggressive | 0.7801 | 0.5929 | 0.4506 |
| (4) Linear Kalman Filters (user only) | 0.7609 | 0.5827 | 0.4542 |
| (5) Extended (non-linear) Kalman Filters | 0.7465 | 0.5651 | 0.4636 |

7.2 Extended Kalman Filters Coupled with MAB

This second set of experiments is performed on the MovieLens dataset only. The experimental protocol is aimed at the evaluation of MAB strategies. It is assumed that users enter in the system exactly as the initial datasets (so the t and u values are retained from the original sequence of tuples <u,i,r,t>), but the system is allowed to propose another item than the one that was chosen in the original sequence. It is also assumed that all items are available from the beginning (this is of course a simplified approximation of the reality). Each time the system proposes an item, it receives a “reward” or relevance feedback, which is 1 if the item was rated at least 4 and 0 otherwise. To be able to determine a reward value, during the item selection process, the items that the user never rated are excluded. Different selection strategies are compared:

(1) GREEDY: A “pure exploitation” (or “one-shot” strategy), that greedily chooses the item not yet seen by the user that has the maximum predicted value, as given by the Extended Kalman Filters;

(2) UCB: A UCB-sampling strategy (with α=2);

(3) THOMPSON: A Thompson sampling strategy (optimistic variant; pre-multiplying the variances/covariances by 0.5).

The metrics used are the average precision (or equivalently the average reward) and the average recall after the system has presented n items to a user (n=10, 50 and 100). The average is computed over all users who have rated at least 100 items. The Extended Kalman Filters derived from the first set of experiments (Adaptive Matrix Completion) are used, applied from the beginning of the dataset. The results are given in TABLE 3.

TABLE 3
Evolution of Precision and Recall (Learning Curves) with
Different Strategies

| | Precision @n | | | Recall @n | | |
|---|---|---|---|---|---|---|
| Strategies | P@10 | P@50 | P@100 | R@10 | R@50 | R@100 |
| Greedy | 0.464 | 0.363 | 0.281 | 0.034 | 0.137 | 0.259 |
| UCB | 0.457 | 0.367 | 0.295 | 0.030 | 0.142 | 0.286 |
| Thompson | 0.459 | 0.369 | 0.302 | 0.031 | 0.145 | 0.291 |

Paired t-tests indicate that both UCB and Thompson sampling strategies significantly outperform the greedy one at n=50 and n=100. Thompson sampling gives slightly better performance than UCB at n=100, but at the limit of the significance (p-value=0.051).

A single framework that combines the adaptive tracking of user/item latent factors through Extended Non-linear Kalman filters and the exploration/exploitation trade-off used by the exemplary on-line learning setting (including cold-start) through Multi-Armed Bandits strategies has been described. Experimental results show that, at least for the datasets and settings that were considered, this framework provides a useful alternative to other approaches without being computationally expensive.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for updating a predicted ratings matrix comprising:
receiving an observation, the observation identifying a user, an item, an observed rating of the user for the item, and a time of the observation;
with a processor, updating user and item latent factor matrices and user and item biases using extended Kalman filters based on the observation, the user latent factor matrix including latent factors for each of a set of users, the item latent factor matrix including latent factors for each of a set of items; and
updating a predicted ratings matrix as a function of the updated user latent factor matrix and the updated item latent factor matrix.

2. The method of claim 1, further comprising:
receiving a request for one of:
an item to be recommended to a specified user, and
a user to be recommended for a specified item; and
generating a recommendation based on the request.

3. The method of claim 2, wherein the generating of the recommendation comprises:
applying a sampling strategy for identifying the one of the item to be recommended to the specified user and the user to be recommended for the specified item, the sampling strategy providing a balance between:
recommending an item or user that is predicted to satisfy the user and recommending an item or user that is predicted to improve optimizes a function of the user and item latent factor matrices and user and item biases, and
recommending an item or user that improves estimates of parameters related to the user and item in the recommendation, the parameters including a user bias, an item bias, and the latent factors of the user and item latent factor matrices relating to the item and user in the recommendation.

4. The method of claim 2, wherein the generating of the recommendation comprises applying a sampling strategy based on at least one of Upper Confidence Bounds sampling and Thompson sampling.

5. The method of claim 4, wherein the Upper Confidence Bounds sampling selects an item i* which optimizes a function of:
$$+ + + α \sqrt{{σ}^{2} + {P}_{t \vert t}^{{a}_{u}} + {P}_{t \vert t}^{{b}_{i}} + {P}_{t \vert t}^{{L}_{u}} + {P}_{t \vert t}^{{R}_{i}} } ,$$
where: [symbol]
, [symbol] , [symbol] , and [symbol] , are estimates of the user latent factor matrix, item latent factor matrix, user bias, and item bias, respectively, at the sampling time t,
α is a non-zero weight;
σ is the standard deviation of noise in user ratings;
P_{t|t}^{a}^{ᵤ}, P_{t|t}^{b}^{ᵢ}, P_{t|t}^{L}^{ᵤ}, and P_{t|t}^{R}^{ᵢ} are covariances for the user bias, item bias, a row of the user latent factor matrix corresponding to the user, and a row of the item latent factor matrix corresponding to the item, respectively, at time t.

6. The method of claim 4, wherein the Thompson sampling selects an item i* which optimizes a function of:
\tilde{L}_{u,t}\tilde{R}_{i,t}+ã_{u,t}+\tilde{b}_{i,t}, where
\tilde{L}_{u,t}, \tilde{R}_{i,t}, ã_{u,t} and \tilde{b}_{i,t} are drawn from a multi-variate probability distribution with mean and covariance matrices computed by the extended Kalman filters.

7. The method of claim 1, wherein the updating user and item latent factor matrices using extended Kalman filters comprises:
based on the observation, updating respective latent factors of the user and item latent factor matrices and the user and item biases for the respective user and item using a predictor step and an iterative corrector step.

8. The method of claim 7, wherein in the predictor step, covariance estimates are computed for the user bias, the item bias, and for the respective rows of the user and item latent factor matrices as a function of the respective covariance estimates at a respective prior time when an observation concerning the respective user or item was made and a respective difference in time between the time of the observation and the prior time.

9. The method of claim 7, wherein in the corrector step, rows of the user and item latent factor matrices are initialized with their prior values at the prior time, the method comprising, for at least one iteration:
a) computing an update factor as a function of the prior covariance estimates and the standard deviation of a noise probability distribution,
b) computing a user latent factor filter gain matrix for the latent factors of the user latent factor matrix corresponding to the user as a function of the update factor, a user bias covariance estimate at the time of the observation, and the respective latent factors of the user latent factor matrix;
c) computing an item latent factor filter gain matrix for the latent factors of the item latent factor matrix corresponding to the item as a function of the update factor, the user bias covariance estimate at the time of the observation, and the respective latent factors of the item latent factor matrix; and
d) updating the respective latent factors of the user latent factor matrix and item latent factor matrix as a function of the respective filter gain matrix, the rating of the user for the item, the user bias at a prior time, the item bias at the prior time, and an estimate of the rating of the user for the item at the prior time.

10. The method of claim 9, wherein the at least one iteration comprises a plurality of iterations.

11. The method of claim 10, further comprising, after the at least one iteration:
computing user bias and item bias filter gain values as a function of the update factor at the time of the observation and the respective prior user bias and item bias covariance estimates.

12. The method of claim 7, wherein:
in the predictor step, covariance matrices P_{t|t-1}^{a}^{ᵤ}, P_{t|t-1}^{b}^{ᵢ}, P_{t|t-1}^{L}^{ᵤ}, P_{t|t-1}^{R}^{ᵢ}, for the user bias, item bias, user latent factors, and item latent factors are updated according to:
P_{t|t-1}^{a}^{ᵤ}=P_{t-1|t-1}^{a}^{ᵤ}+Δᵤ(t,t−1)γₐ,
P_{t|t-1}^{b}^{ᵢ}=P_{t-1|t-1}^{b}^{ᵢ}+Δᵢ(t,t−1)γ_{b},
P_{t|t-1}^{L}^{ᵤ}=P_{t-1|t-1}^{L}^{ᵤ}+Δᵤ(t,t−1)Γ_{L}, and
P_{t|t-1}^{R}^{ᵢ}=P_{t-1|t-1}^{R}^{ᵢ}+Δᵢ(t,t−1)Γ_{R}, and
in the corrector step, the method includes:
a) initializing [symbol] ← [symbol] and [symbol] ← [symbol] ,
b) iterating:
ω=(σ²+P_{t|t-1}^{a}^{ᵤ}+P_{t|t-1}^{b}^{ᵢ}+ [symbol] P_{t|t-1}^{L}^{ᵤ} [symbol] + [symbol] P_{t|t-1}^{R}^{ᵢ} [symbol] )⁻¹,
Kₜ^{L}^{ᵤ}=ωP_{t|t-1}^{L}^{ᵤ} [symbol] ,
Kₜ^{R}^{ᵢ}=ωP_{t|t-1}^{R}^{ᵢ} [symbol] , [symbol]
= [symbol] +Kₜ^{L}^{ᵤ}(r_{u,i,t}−μ− [symbol] − [symbol] − [symbol] [symbol] ), and [symbol]
= [symbol] +Kₜ^{R}^{ᵢ}(r_{u,i,t}−μ− [symbol] − [symbol] − [symbol] [symbol] ); and
thereafter, updating the filter gains, user and item biases, and covariances according to:
Kₜ^{a}^{ᵤ}=ωP_{t|t-1}^{a}^{ᵤ},
Kₜ^{b}^{ᵢ}=ωP_{t|t-1}^{b}^{ᵢ}, [symbol]
= [symbol] +Kₜ^{a}^{ᵤ}(r_{u,i,t}−μ− [symbol] − [symbol] − [symbol] [symbol] ), [symbol]
= [symbol] +Kₜ^{b}^{ⱼ}(r_{u,i,t}−μ− [symbol] − [symbol] − [symbol] [symbol] ),
P_{t|t}^{a}^{ᵤ}=P_{t|t-1}^{a}^{ᵤ}(1−Kₜ^{a}^{ᵤ}),
P_{t|t}^{b}^{ᵢ}=P_{t|t-1}^{b}^{ᵢ}(1−Kₜ^{b}^{ᵢ}),
P_{t|t}^{L}^{ᵤ}=(I−Kₜ^{L}^{ᵤ} [symbol] )P_{t|t-1}^{L}^{ᵤ}, and
P_{t|t}^{R}^{ᵢ}=(I−Kₜ^{R}^{ᵢ} [symbol] )P_{t|t-1}^{R}^{ᵢ}.

13. The method of claim 1, wherein the at least one observation includes a plurality of observations received at different times.

14. The method of claim 1, further comprising outputting at least one of the predicted ratings matrix and a recommendation based thereon.

15. The method of claim 1, wherein when there are no prior observations for the user, establishing values for covariance estimates of the user bias and user latent factors.

16. A computer program product comprising a non-transitory recording medium storing instructions, which when executed on a computer, causes the computer to perform the method of claim 1.

17. A system comprising memory which stores instructions for performing the method of claim 1 and a processor which executes the instructions.

18. A system for updating a predicted ratings matrix comprising:
an adaptive matrix completion component which:
updates user and item latent factor matrices and user and item biases using extended Kalman filters based on the observation, the user latent factor matrix including latent factors for each of a set of users, the item latent factor matrix including latent factors for each of a set of items; and
updates a predicted ratings matrix as a function of the user updated latent factor matrix and the updated item latent factor matrix; and
a processor device which implements the adaptive matrix completion component.

19. The system of claim 18, further comprising a recommendation component which receives a query, accesses the predicted ratings matrix with the query, and outputs a recommendation based on at least one entry in the predicted ratings matrix.

20. The system of claim 18, wherein the recommendation component applies a sampling strategy for identifying the one of the item to be recommended to the specified user and the user to be recommended for the specified item, the sampling strategy providing a balance between:
recommending an item or user that is predicted to satisfy the user and recommending an item or user that is predicted to improve optimizes a function of the user and item latent factor matrices and user and item biases, and
recommending an item or user that improves estimates of parameters related to the user and item in the recommendation, the parameters including a user bias, an item bias, and the latent factors of the user and item latent factor matrices relating to the item and user in the recommendation.

21. A method for making a recommendation, comprising:
for a plurality of iterations:
receiving an observation, each observation identifying a user, an item, an observed rating of the user for the item, and a time of the observation;
updating user and item latent factor matrices and user and item biases using extended Kalman filters, based on the observations, the user latent factor matrix including latent factors for each of a set of users, the item latent factor matrix including latent factors for each of a set of items; and
updating a predicted ratings matrix as a function of the user latent factor matrix and the item latent factor matrix;
receiving a request for an item to be recommended to a user;
identifying an item to recommend to the user using multi-arm bandit sampling; and
outputting the identified item.
